(19) United States
(12) Patent Application Publication
(10) Pub. No.: US 2011/0222810 A1
(43) Pub. Date: Sep. 15, 2011

(54) HYGIENIC ROLLER ASSEMBLY WITH EXTERNAL BEARING AND METHOD OF ASSEMBLING A ROLLER ASSEMBLY

(76) Inventors: Vadim A. Lubezny, Buffalo Grove, IL (US); Detlev D. Ansinn, Bridgman, MI (US)

(21) Appl. No.: 12/724,101

(22) Filed: Mar. 15, 2010

(51) Int. Cl. F16C 13/02; B23P 11/00

(52) U.S. Cl. 384/549; 29/428; 492/60

(57) ABSTRACT

A roller assembly includes a hermitically sealed roller defining a longitudinal axis of rotation. An external bearing supports the roller. In one embodiment, the bearing includes a plurality of fingers defining a bearing surface. In one embodiment, the roller is laterally moveable through an opening in the bearing to a support position. In one embodiment, the roller may lock the bearings against a support structure. An external bearing and a method of assembling a roller assembly are also provided.

### FIELD OF THE INVENTION

The present invention relates generally to a roller assembly, and in particular to a hygienic roller assembly, external bearing and method of assembling the roller assembly.

### BACKGROUND

It is important to maintain hygienic conditions in various food packaging environments. Often, food products, including without limitation fresh or cooked protein products, such as meat or fish, and/or dairy products, are packaged with various packaging machines, including without limitation form, fill and seal machines as disclosed for example and without limitation U.S. Pat. Nos. 5,715,656 and 5,752,370. Such packaging machines often use various roller devices to support rolls of packaging film and other such items. Typically, the rollers are not hermitically sealed, and are configured with various bearings secured in and to the ends thereof. Moreover, the bearings often are not removable, making the rollers and bearings difficult to clean and sanitize. As such, the rollers may be susceptible to microbial pathogen growth, and may not be easy to clean and sanitize. Moreover, typical designs usually include various seals, lubricants and the like, which may not be resistant to various cleaning agents, especially those used in the protein and dairy packaging industries.

In addition, various roller systems typically require a mechanic and tools for installation, with the attendant possibility of loose fastener parts that may be misplaced and/or lost. As such, the process for removing, cleaning and installing various rollers may be time consuming.

### SUMMARY

The present invention is defined by the following claims, and nothing in this section should be considered to be a limitation on those claims.

In one aspect, one embodiment of a roller assembly includes a hermitically sealed roller defining a longitudinal axis of rotation. A bearing includes a base portion and a plurality of fingers extending longitudinally from the base portion. The fingers are radially spaced from the longitudinal axis, with at least one of the fingers having a bearing surface formed along an inner sidewall thereof. The bearing surface of the at least one finger rotatably supports the roller.

In another aspect, one embodiment of a roller assembly includes a hermitically sealed roller defining a longitudinal axis of rotation. A bearing includes a base portion and a bearing member extending longitudinally from the base portion. The bearing member has a bearing surface formed along an inner wall thereof. The bearing member has at least one opening formed therein such that the bearing surface does not extend circumferentially around the entirety of the roller. The roller is laterally moveable through the opening in a direction substantially perpendicular to the longitudinal axis from an unsupported position to a supported position, wherein the bearing surface of the bearing member rotatably supports the roller when the roller is in the supported position.

In yet another aspect, a roller assembly includes a pair of longitudinally spaced apart support structures and a pair of longitudinally spaced external bearings. The bearings are aligned along a longitudinal axis and are moveable along the longitudinal axis between a released position wherein the external bearings are not coupled to the support structures and an engaged position wherein each of the bearings is releasably coupled to one of the support structures. A roller is laterally moveable in a direction substantially perpendicular to the longitudinal axis from a first position to a second position, wherein the roller is supported by the pair of external bearings when the roller is in the second position and the external bearings are in the engaged position, and wherein the roller locks the external bearings in the engaged position against the pair of support structures when the roller is in the second position. The roller is not supported by the bearings when the roller is in the first position. The external bearings are releasable from the pair of support structures to the released position when the roller is in the first position.

In yet another aspect, one embodiment of an external bearing includes a base portion and a plurality of fingers extending from the base portion in a first direction. The fingers each have a bearing surface formed along a side thereof, with the bearing surfaces defining in combination portions of a circle. A support element extends from the base in a second direction opposite the first direction.

In yet another aspect, a method of assembling a roller assembly includes inserting a pair of longitudinally spaced external bearings in a pair of longitudinally spaced apart support structures, wherein the bearings are aligned along a longitudinal axis. The method further includes moving a roller in a lateral direction substantially perpendicular to the longitudinal axis such that the roller is supported by the pair of external bearings, thereby locking the external bearings against the pair of support structures. The method further includes moving the roller opposite the lateral direction and thereby removing the roller from the bearings and unlocking the external bearings. The method further includes removing the external bearings from the support structures.

The various embodiments of the roller assembly, external bearing and methods of assembling a roller assembly provide significant advantages over other roller assemblies and methods. For example and without limitation, the roller and external bearings are both separable and hermitically sealed, such that they inhibit and prevent microbial pathogen growth. The components, as well as the support structure, may be quickly and easily disassembled without tools. Moreover, the system is self retaining, low cost and easy to manufacture.

Moreover, the individual components, including the support structure, roller and bearings, may be easily cleaned and sanitized in accordance with the applicable Current Good Manufacturing Practices (CGMP's), as set forth for example at EC92-2308 Principles and Practices for Food Sanitation Programs, authored by Susan S. Sumner and Dianne L. Peters, University of Nebraska at Lincoln, the entire disclosure of which is hereby incorporated herein by reference. For example, in one embodiment, there are no exposed threads, bearings, seals, lubricants or hollow spaces associated with the components. In addition, the components may be made of materials that are resistant to corrosion when exposed to various aggressive cleaning and sanitizing agents used in the protein and dairy processing industries, including without limitation chlorinated alkaline detergents, acid washes, chorine, iodine, and quaternary ammonia. In addition, as mentioned, the components can be quickly and easily disassembled for off-line cleaning and sanitization, thereby reducing downtime, with a new system being installed and the machine run while the other system is being cleaned.

The foregoing paragraphs have been provided by way of general introduction, and are not intended to limit the scope of the following claims. The various preferred embodiments, together with further advantages, will be best understood by reference to the following detailed description taken in conjunction with the accompanying drawings.

### BRIEF DESCRIPTION OF THE DRAWINGS

FIG. 1 is a perspective view of one embodiment of a film cage where rolls of film are unrolled.

FIG. 2 is a rear view of one roller assembly including a support structure.

FIG. 3 is an enlarged, partial cutaway view of the roller assembly taken along line 3 of FIG. 2.

FIG. 4 is a cross sectional view of the roller assembly taken along line 4-4 of FIG. 3.

FIG. 5 is an end view of the roller assembly taken along line 5-5 of FIG. 3.

FIG. 6 is an outer exploded, perspective view of one embodiment of a roller assembly.

FIG. 7 is an inner exploded, perspective view of one embodiment of a roller assembly.

FIG. 8 is a front view of one roller assembly including a support structure.

FIG. 9 is a perspective view of one embodiment of an external bearing.

FIG. 10 is an end view of an alternative embodiment of an external bearing.

### DETAILED DESCRIPTION OF THE PRESENTLY PREFERRED EMBODIMENTS

General:

It should be understood that the term “plurality,” as used herein, means two or more. The term “longitudinal,” as used herein means of or relating to length or the lengthwise direction. The term “lateral,” as used herein, means situated on, directed toward or running from side to side, and includes a direction transverse to the longitudinal direction. The term “coupled” means connected to or engaged with whether directly or indirectly, for example with an intervening member, and does not require the engagement to be fixed or permanent, although it may be fixed or permanent, and includes both mechanical and electrical connection. The terms “first,” “second,” and so on, as used herein are not meant to be assigned to a particular component so designated, but rather are simply referring to such components in the numerical order as addressed, meaning that a component designated as “first” may later be a “second” such component, depending on the order in which it is referred. It should also be understood that designation of “first” and “second” does not necessarily mean that the two components or values so designated are different, meaning for example a first velocity may be the same as a second velocity, with each simply being applicable to different components and/or time periods.

U.S. Pat. Nos. 5,715,656 and 5,752,370, assigned to Triangle Package Machinery Company, the same Assignee as the present application, disclose various components of form, fill and seal machines, the entirety of which patents are hereby incorporated herein by reference.

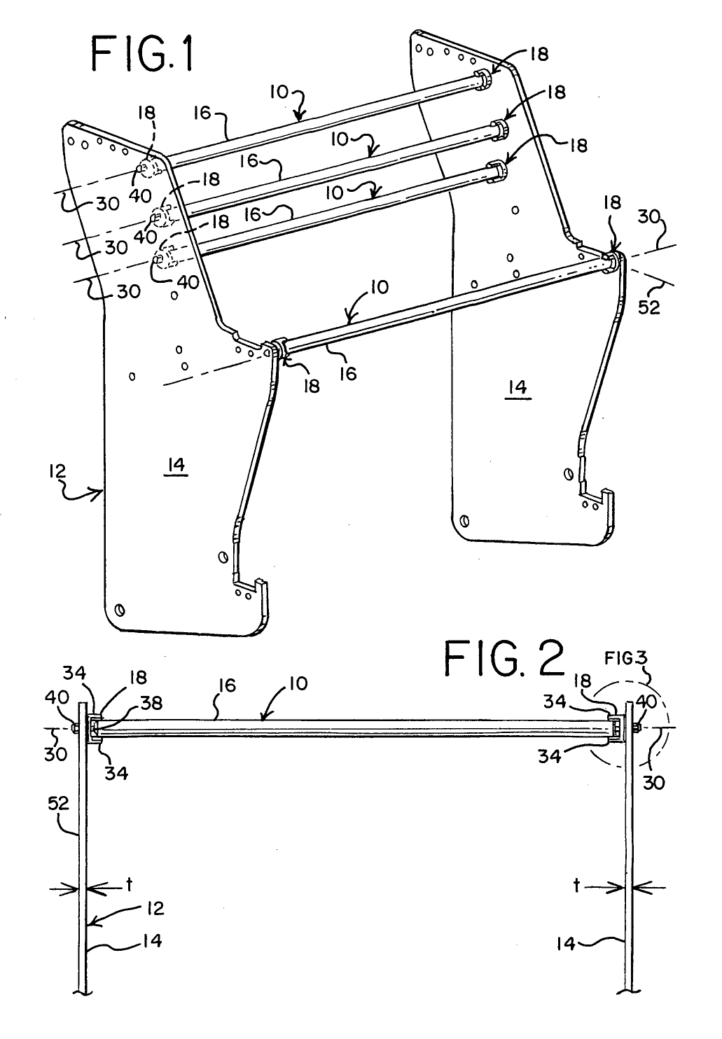

Referring to FIG. 1, form, fill and seal machines typically include a film cage 6 configured to hold and unwind rolls of film. The film cage includes dancer rollers (not shown) that control/maintain the tension of the film as it is introduced to the machine. The dancer rolls speed up or slow down the power unwind of the film from the film roll. The film is threaded between the dancer rollers and a series of fixed roller assemblies 10, which are secured to a support structure 12, shown as a pair of spaced apart side plates 14, each having a thickness (t). It should be understood that the roller assemblies described herein may also be suitable for use as the dancer rollers.

Roller Assemblies:

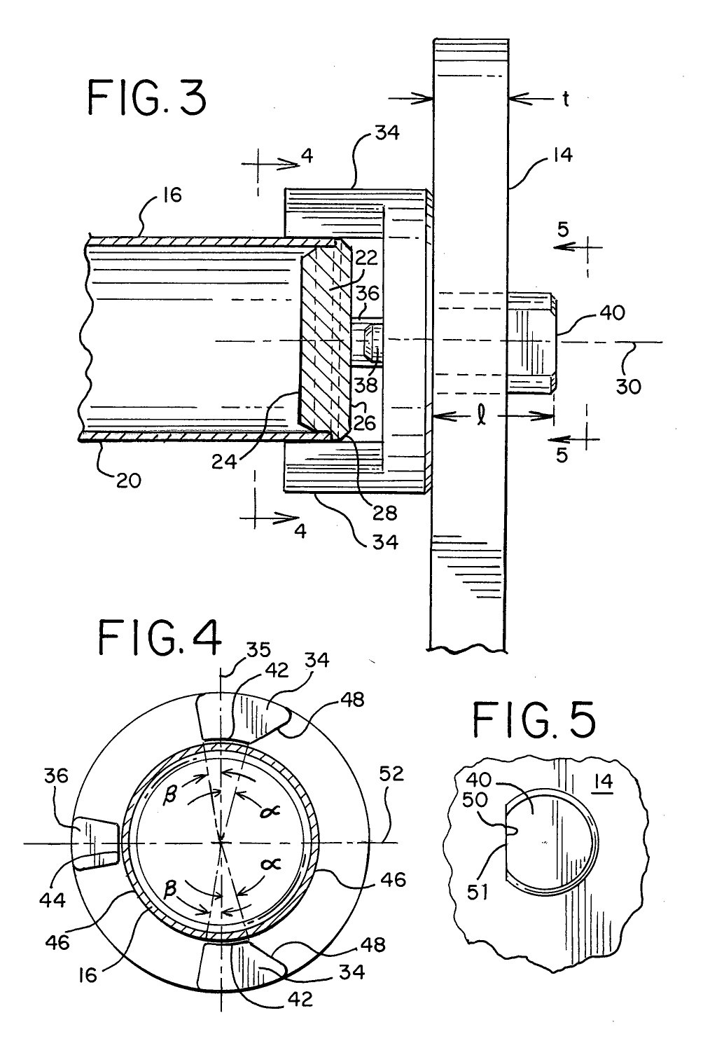

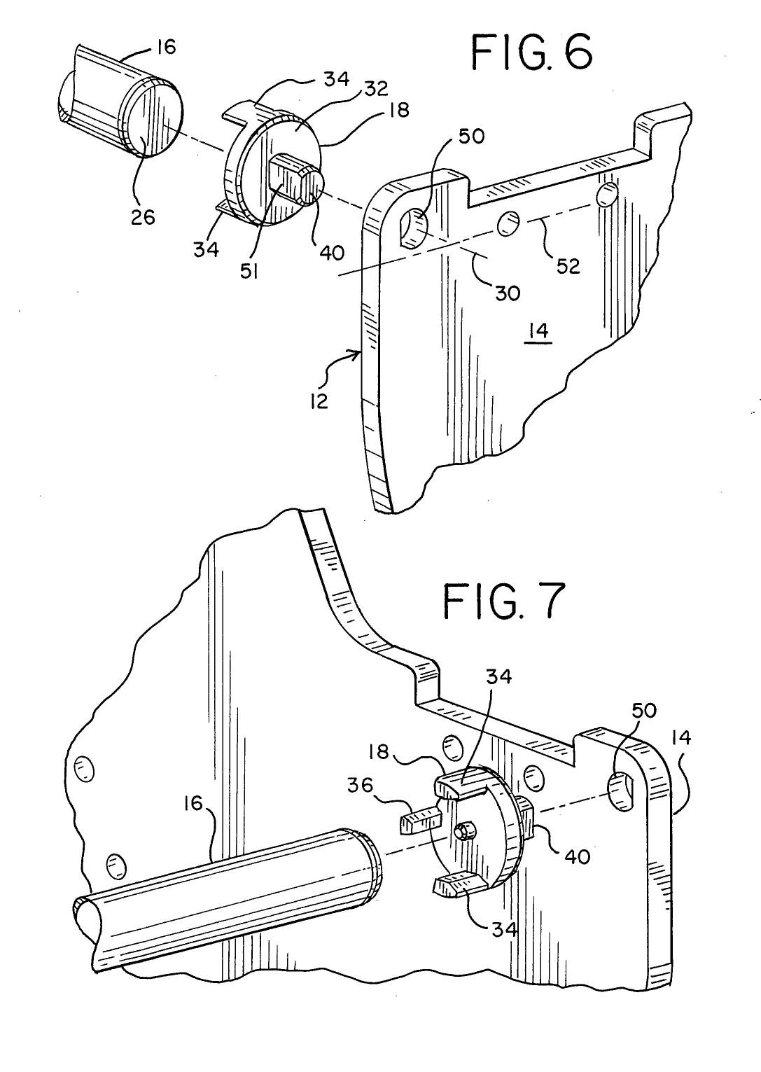

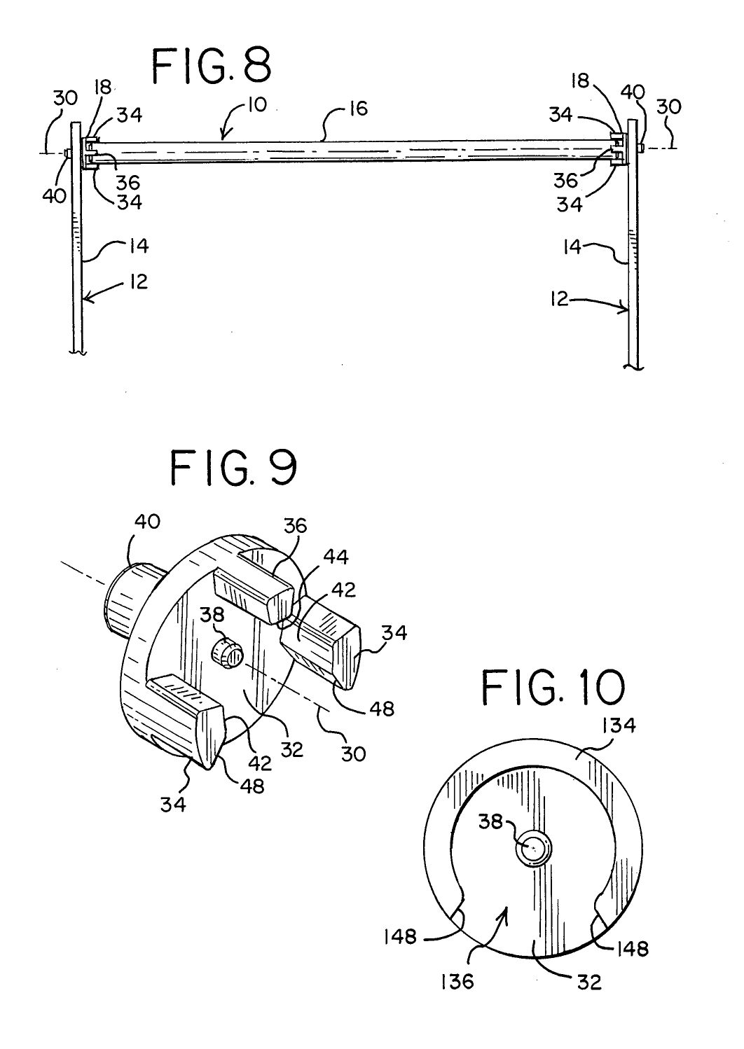

Referring to FIGS. 1-4 and 6-8, each roller assembly 10 includes a roller 16 and a pair of external bearings 18. Each roller 16 includes a cylindrical structure, whether a tube 20 or a bar. Each roller defines a longitudinal axis 30. In one embodiment, the roller is configured as a low inertia film roller, made for example and without limitation from a thin wall seamless drawn stainless steel tubing of a predetermined length, prescribed for example by the width of the machine or film. For example, in one embodiment, the tube is formed from a 1.00 inch (outer diameter) by 0.035 inch (wall thickness) 316 stainless steel tube. It should be understood that other sizes and materials, including without limitation other stainless steels or aluminum tubes may also be suitable.

In one embodiment, each end of the tube is closed with an end cap 22 or plug, made for example of stainless steel. The end cap has an insert portion 24 that is fitted inside and closes off the end of the tube. A cap portion 26 has an outer diameter that approximately matches the outer diameter of the tube 20. The cap portion may have a chamfer 28 formed around an outer edge thereof. The end cap 22 is hermitically sealed to the tube 20, for example by welding (laser), bonding, combinations thereof and/or other known techniques. The term “hermitically sealed” means no fluids, whether gas or liquid, can penetrate or reach the inside of the tube. An indicating dye is provided inside the sealed tube, such that any breaches in the welds or tube will be made evident by the dye escaping there through, thereby providing indicia that the sealed tube has been compromised and that the tube should be replaced.

Referring to FIGS. 1-10, one embodiment of an external bearing 18 is configured with a base portion 32 and a bearing member 34, 36, 134 extending longitudinally from the base portion. In one embodiment, the bearing member is made of a low friction polymer, including those approved by the USDA for direct food contact, for example PTFE Filled Acetal/Low Friction/FDA/USDA, and including compounds with static electricity conduction characteristics. In one embodiment, shown in FIGS. 1-9, the bearing member is configured as a plurality of bearing fingers 34, 36, each having a bearing surface 42, 44 formed along an inner sidewall thereof. The bearing surfaces support an outer surface 46 of the roller.

In one embodiment, the bearing member is configured with three fingers, including two larger fingers 34 and one smaller finger 36. The fingers are non-uniformly circumferentially spaced around the roller and longitudinal axis 30, such that two of the fingers 34 define an angular interval there between allowing a roller to be inserted radially or laterally through a space between the fingers until it is captured by the fingers, for example with a snap-fit. For example, in one embodiment, two fingers 34 are formed approximately 180 degrees relative to each other, such that they are spaced along an axis 35, with the bearing surface of each finger extending at least a minimum angle α relative to the axis 35 so as to engage and capture the roller. In various embodiments, α is between about 5 and 25 degrees, and in one embodiment approximately 15 degrees. The bearing surface of the fingers also extends in an opposite angular direction relative to the axis 35 at an angle β. The third finger 36 is disposed between the fingers, with a midpoint thereof forming an angle of 90 degrees relative to the axis 35. It should be understood that the bearing surfaces 42, 44 may be rounded and proximate the outer diameter of the roller, or may have a flat or lesser curvature as compared with the roller 16. In one embodiment, the bearing surface 44 of the finger 36 absorbs the entire load from the roller during operation. At least portions of the bearing surfaces define portions of a circle, which proximates (slightly larger than) the outer diameter of the roller. The bearing surfaces engage and support the roller, although a slight space may be presented between the bearing surface and the outer surface of the roller to accommodate various tolerances, and/or when a force is applied to the roller during operation. It should also be understood that the bearing members may be spaced at other angular intervals, or may be uniformly disposed around the roller.

In the embodiment of FIG. 10, the bearing member 134 is configured as a partial circumferential wall that has an opening 136 formed therein to permit the radial or lateral insertion of the roller. It should be understood that other bearing member configurations may also be suitable, including a pair of fingers or walls, or more than three fingers.

As shown in FIGS. 4 and 10, the fingers 34 and wall 134 have a ramped surface 48, 148 (whether linear or curved) defining the sides of the mouth, with the ramped surfaces guiding the roller 16 as the roller is inserted through the mouth and into the interior space defined by the bearing member 34, 36, 134. The bearing may also include a spacer 38 extending longitudinally from the base along the longitudinal axis 30. The spacer 38 is shorter than the bearing members 34, 36, 134, and is sized to limit the side-side movement of the rollers along the longitudinal axis 30 with minimal friction. Moreover, the roller 16 interface with the spacer 30 ensures that the bearings are retained in the support structure 14 once the rollers 16 are installed.

In one embodiment, the bearings 18 are oriented and non-rotatably fixed to the support structure 12 such that the single middle finger 36 carries the film tension load, leaving a clearance to the other two fingers 34 during operation, for example with a load is applied to the roller during operation, including for example and without limitation the unwinding of a packaging film from the roller. The orientation of the bearings 18 is maintained by a support element 40 that extends from the base in a longitudinal direction opposite the bearing member, preferably along the longitudinal axis. In one embodiment, the support element 40 is configured with a D-shaped key portion 51 that is shaped and sized to mate with a D-shaped opening 50 formed in the support plates 14. In this way, the interface between the key portion and key passageway non-rotatably couples the bearing 18 to the support plate 14, while also orienting the bearing such that the finger 36 carries the tension loads of the film. In this way, the actual bearing surface of finger 36 in contact with the roller is minimized, thereby reducing the friction force applied to the roller.

The support element 40 has a length (l) that is greater than the thickness (t), such that the support element 40 extends beyond an outer surface 52 of the support structure a distance (l−t) and can be engaged by a user, for example by a hand or finger, for pushing the support element 40 and bearing 18 out of the support plate 14 such that the bearing can be more easily grasped on the other side during disassembly. It should be understood that, in an alternative embodiment, the support element could be configured as a plurality of fingers that engage various openings to secure and maintain the orientation of the bearing.

It should be understood that the roller assembly, including the roller 16 and external bearings 18, may be used in any situation or environment, including without limitation the food processing environment. Such rollers may also be suitable for use in various manufacturing facilities, including paper, felt, fiberglass mat, and film manufacturing mills and plants.

It also should be understood that the installer/user may maintain separate inventories of external bearings and rollers. In addition, the roller assemblies can be shipped and sold as kits, with each kit including at least one roller 16 and at least a pair of external bearings 18 for each roller.

Assembly and Disassembly:

To install and assemble a roller assembly, the installer first selects a pair of bearings 18. The installer grasps each bearing and inserts the support elements 40 of a pair of longitudinally disposed bearings in opposite directions along the longitudinal axis 30 into corresponding openings 50 of a pair of longitudinally spaced support plates 14, with the key portion 51 and key passageway 50 of the support elements used to align and orient the bearing 18 with the support structure 14. In this way, the bearings 18 are moved from a released position to an engaged position. A roller 16 is then inserted laterally through the mouth of the longitudinally spaced bearings in a direction 52 substantially perpendicular to the longitudinal axis 30. The roller 16 is captured and supported by the bearing members 18, for example with a snap-fit. At the same time, the roller 16 locks the bearings 18 to the support structure 12 in the engaged position, since the bearings cannot be moved a sufficient longitudinal distance along axis 30 to remove the support elements 40 due to the engagement of the end of the roller with the base, or spacer 38 if provided.

After a predetermined period of use, whether defined by a length of time of operation or the need for a product switch over, the roller 16 is removed from the bearings 18 by moving the end portions of the roller laterally through the mouths of the bearings in a lateral direction 52. After the roller is removed, the bearings 18 are no longer locked in the engaged position. The installer may then push on the support elements 40, and/or pull on the base 32 and bearing member, thereby moving the bearings to a released position. In this way, the bearings and rollers may be installed and removed quickly and easily without the use of tools.

After removal, the support structure 12, roller 16 and bearings 18 may be cleaned and sanitized with various agents. In order to minimize down time, the support structure may be cleaned first, with new, sanitized rollers and bearings installed for further operation. The dirty roller and bearings may thereafter be cleaned for further use.

Because the roller and external bearings are both separable and hermitically sealed, microbial pathogen growth is inhibited. For example, as disclosed herein, the roller assembly does not have any exposed threads, roller bearings, seals, lubricants or hollow spaces associated with the components. In addition, the components may be made of materials that are resistant to corrosion when exposed to various aggressive cleaning agents used in the protein and dairy processing industries, including without limitation chlorinated alkaline detergents, acid washes, chorine, iodine, and quaternary ammonia. As such, the individual components, including the support structure, roller and bearings, may be easily cleaned and sanitized in accordance with the applicable Current Good Manufacturing Practices (CGMP's).

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

What is claimed is:

1. A roller assembly comprising:
a hermitically sealed roller defining a longitudinal axis of rotation; and
a bearing comprising a base portion and a plurality of fingers extending longitudinally from said base portion, wherein said fingers are radially spaced from said longitudinal axis, at least one of said fingers having a bearing surface formed along an inner sidewall of said finger, wherein said bearing surface of said at least one finger rotatably supports said roller.

2. The roller assembly of claim 1 wherein said fingers are non-uniformly circumferentially spaced around said roller, wherein a plurality of angular intervals are defined between said plurality of adjacent fingers relative to said longitudinal axis, wherein at least some of said angular intervals are different.

3. The roller assembly of claim 2 wherein at least one of said angular intervals is sized to permit a radial insertion of said roller between said adjacent fingers spaced apart at said at least one angular interval.

4. The roller assembly of claim 3 wherein said plurality of fingers comprises three fingers, wherein two of said fingers defining said at least one angular interval comprise ramped surfaces defining the space between said two fingers.

5. The roller assembly of claim 3 wherein said plurality of fingers extend longitudinally from said base portion in a first direction, and further comprising a support element extending longitudinally from said base in a second direction opposite said first direction.

6. The roller assembly of claim 5 wherein said support element comprises a key portion.

7. The roller assembly of claim 6 further comprising a support structure having an opening defining a key passageway shaped to receive said key portion, wherein said key portion is inserted into said key passageway such that said support element is non-rotatably coupled to said support structure.

8. The roller assembly of claim 7 wherein said support structure comprises first and second surfaces defining a thickness, wherein said opening is formed through said thickness, and wherein said base is disposed adjacent said first surface of said support structure, and wherein said support element has a length greater than said thickness, wherein said support element extends through said opening and has an end portion spaced from said second surface of said support structure.

9. The roller assembly of claim 6 wherein said key portion has a D-shaped cross-section.

10. The roller assembly of claim 1 further comprising a spacer member extending from said base portion and positioned radially inwardly from said fingers.

11. The roller assembly of claim 10 wherein said spacer member is shorter than said fingers and is located proximate the longitudinal axis.

12. The roller assembly of claim 1 wherein said bearing is made of a polymeric material.

13. A roller assembly comprising:
a hermitically sealed roller defining a longitudinal axis of rotation; and
a bearing comprising a base portion and a bearing member extending longitudinally from said base portion, wherein said bearing member has a bearing surface formed along an inner wall thereof, said bearing member having at least one opening formed therein such that said bearing surface does not extend circumferentially around the entirety of the roller, wherein said roller is laterally moveable through said opening in a direction substantially perpendicular to said longitudinal axis from an unsupported position to a supported position, wherein said bearing surface of said bearing member rotatably supports said roller when said roller is in said supported position.

14. The roller assembly of claim 13 wherein said bearing member comprises a plurality of fingers, at least a pair of said fingers being circumferentially spaced so as to define said at least one opening therebetween.

15. A roller assembly comprising:
a pair of longitudinally spaced apart support structures;
a pair of longitudinally spaced external bearings, wherein said bearings are aligned along a longitudinal axis and are moveable along said longitudinal axis between a released position wherein said external bearings are not coupled to said support structures and an engaged position wherein each of said bearings is releasably coupled to one of said support structures; and
a roller laterally moveable in a direction substantially perpendicular to said longitudinal axis from a first position to a second position, wherein said roller is supported by said pair of external bearings when said roller is in said second position and said external bearings are in said engaged position, and wherein said roller locks said external bearings in said engaged position against said pair of support structures when said roller is in said second position, and wherein said roller is not supported by said bearings when said roller is in said first position, and wherein said external bearings are releasable from said pair of support structures to said released position when said roller is in said first position.

16. The roller assembly of claim 15 wherein said roller is snap-fitted to said pair of external bearings as said roller is moved from said first position to said position.

17. The roller assembly of claim 15 wherein each of said bearings comprises a bearing member having a bearing surface formed along an inner radial wall thereof, said bearing members each having at least one opening formed therein such that said bearing surface does not extend circumferentially around the entirety of said roller when said roller is in said second position, wherein said roller is laterally moveable through said opening between said first and second positions.

18. An external bearing adapted to support a roller comprising:
a base portion;
a plurality of fingers extending from said base portion in a first direction, said fingers each having a bearing surface formed along a side thereof, wherein said bearing surfaces define in combination portions of a circle; and
a support element extending from said base in a second direction opposite said first direction.

19. The external bearing of claim 18 wherein said fingers are non-uniformly circumferentially spaced around said circle, wherein a plurality of angular intervals are defined between said plurality of adjacent fingers relative to a center of said circle, wherein at least some of said angular intervals are different.

20. The external bearing of claim 18 wherein said support element comprises a key portion.

21. The external bearing of claim 20 wherein said key portion has a D-shaped cross-section.

22. The external bearing of claim 18 further comprising a spacer member extending from said base in said first direction and positioned radially inwardly from said fingers.

23. The external bearing of claim 22 wherein said spacer member is shorter than said fingers and is located proximate a center of said circle.

24. A method of assembling a roller assembly comprising:
inserting a pair of longitudinally spaced external bearings in a pair of longitudinally spaced apart support structures, wherein said bearings are aligned along a longitudinal axis;
moving a roller in a lateral direction substantially perpendicular to said longitudinal axis such that said roller is supported by said pair of external bearings and thereby locking said external bearings against said pair of support structures;
moving said roller opposite said lateral direction and thereby removing said roller from said bearings and unlocking said external bearings; and
removing said external bearings from said support structures.

25. The method of claim 24 further comprising cleaning said support structure after removing said external bearings therefrom.

26. The method of claim 24 wherein said moving said roller in said lateral direction further comprises snap-fitting said roller into engagement with said bearings.

27. The method of claim 24 wherein said inserting and removing said external bearings comprises non-threadably inserting and removing a support element from openings formed in said support members.

28. The method of claim 27 wherein said inserting and removing said support elements comprises matching a key portion defined by each of said support elements with a key passageway defined by each of said openings, wherein said support elements are non-rotatably engaged respectively by corresponding ones of said openings.

29. The method of claim 24 wherein each of said bearings comprises a bearing member having a bearing surface formed along an inner wall thereof, said bearing members each having at least one opening, and wherein said moving said roller in said lateral direction and opposite said lateral direction comprises moving said roller through said opening in opposite directions.

30. The method of claim 29 wherein said bearing member comprises a plurality of circumferentially spaced fingers each having a bearing surface.
